(19) United States
(12) Patent Application Publication
(10) Pub. No.: US 2010/0042745 A1
(43) Pub. Date: Feb. 18, 2010

(54) Workflow diagram generation program, apparatus and method

(75) Inventors: Yoshiharu Maeda, Kawasaki (JP); Akihiko Matsuo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/588,547

(22) Filed: Oct. 19, 2009

Related U.S. Application Data
(63) Continuation of application No. PCT/JP2007/060695, filed on May 25, 2007.

(51) Int. Cl. G06F 15/173

(52) U.S. Cl. 709/242

(57) ABSTRACT

In a computer for executing a process in accordance with a workflow diagram generation program, a path extractor extracts processing paths from program information indicating the procedure of a business program, and generates path information indicating read and update processes performed in the individual processing paths and operation screens displayed in the processing paths. A path associator associates each transition relation, which is the relation between two data sets successively updated, with a processing path of which the data set to be read agrees with the data set of the transition source and of which the data set to be updated agrees with the data set of the transition destination. A flow diagram generator generates a workflow diagram which indicates the data sets as nodes and the transition relations as links and in which information indicating the operation screens displayed in the processing paths are annexed to the corresponding links.

This application is a continuing application, filed under 35 U.S.C. §111(a), of International Application PCT/JP2007/060695, filed May 25, 2007.

### FIELD

The embodiments discussed herein are related to workflow diagram generation programs, apparatus and methods.

### BACKGROUND

Currently, business systems using computers are being constructed in a variety of business fields. A business enterprise that sells merchandise to customers, for example, uses a business system for processing data to manage customer information, merchandise inventory, order receipt and the like. An overall business flow handled by the business system (hereinafter referred to as workflow) is so complicated that a workflow diagram is created for ease of understanding the workflow. The workflow diagram is a chart describing the workflow in an easy-to-understand manner. Such a workflow diagram allows the business manager or the system administrator to intuitively comprehend the workflow. In many cases, the workflow diagram is created as part of design information when the business system is constructed.

Meanwhile, it is not just once that the workflow diagram has to be created, and as the business content changes, for example, the workflow diagram needs to be re-created. A great deal of labor is, however, needed to create the workflow diagram. This is because, in general, the system administrator has to hold hearings with or send questionnaires to the business manager and business controllers and also refer to a variety of stored documents before creating the workflow diagram. A problem therefore arises in that it is difficult to create a workflow diagram in a short period of time.

In recent years, workflow visualization techniques have been attracting attention which enable automatic generation of workflow diagrams through the analysis of existing business systems. Specifically, the following two implementation methods have been known. In the first method, the business program run on the business system is analyzed to extract a flow of data processing, and based on the extracted data processing flow, a workflow diagram is generated (see, e.g., Japanese Laid-open Patent Publication No. 09-128021). In the second method, the update history of data managed by the business system is analyzed to infer the flow of data processing, and based on the inferred data processing flow, a workflow diagram is generated (see, e.g., W. M. P. van der Aalst, and five others, “Workflow Mining: A Survey of Issues and Approaches”, obtained online by search conducted on Apr. 25, 2007; URL: http://is.tm.tue.nl/research/processmining/papers/wf-min-surv.pdf). The use of such workflow visualization techniques greatly shortens the time necessary for the creation of workflow diagrams.

However, the techniques disclosed in Japanese Laid-open Patent Publication No. 09-128021 and W. M. P. van der Aalst, and five others, “Workflow Mining: A Survey of Issues and Approaches” (obtained online by search conducted on Apr. 25, 2007; URL: http://is.tm.tue.nl/research/processmining/papers/wf-min-surv.pdf) are associated with problems explained below.

The problem with the visualization method using the business program, disclosed in Japanese Laid-open Patent Publication No. 09-128021, is that the workflow diagram generated does not match the operational status of the business system. This is because not all processing paths included in the business program are used in actual work. Consequently, rarely executed data processing is also depicted in the workflow diagram, so that the ease of understanding the workflow diagram is low.

The visualization method using the update history of data, disclosed in W. M. P. van der Aalst, and five others, “Workflow Mining: A Survey of Issues and Approaches” (obtained online by search conducted on Apr. 25, 2007; URL: http://is.tm.tue.nl/research/processmining/papers/wf-min-surv.pdf), is associated with the problem that it is not easy to grasp the correspondence relationship between the individual elements in the workflow diagram and the work of business controllers. The reason is that most data processing is automatically executed in the background invisible to business controllers, and thus, in order to understand the correspondence relationship, it is necessary to know the internal behavior of the business program.

### SUMMARY

According to one aspect of the present invention, a computer-readable recording medium recording a workflow diagram generation program for generating a workflow diagram matching operational status of a business system is provided, wherein the workflow diagram generation program causes a computer to function as an operational information storage configured to store operational information indicating transition relations each of which is a relation between two data sets successively updated during operation of the business system by a business process involving an update process with respect to a plurality of data sets, a program information storage configured to store program information indicating a procedure of one or more business programs for implementing the business process by means of the business system, a path extractor configured to extract processing paths from the program information stored in the program information storage, and generate path information indicating a read process and an update process performed with respect to the data sets in the individual processing paths and operation screens displayed in the processing paths, a path associator configured to associate each of the transition relations indicated by the operational information stored in the operational information storage, with a processing path of which the data set to be read agrees with the data set of a transition source and of which the data set to be updated agrees with the data set of a transition destination, among the processing paths indicated by the path information generated by the path extractor, and a flow diagram generator configured to generate, based on association results provided by the path associator, a workflow diagram which indicates the data sets as nodes and the transition relations as links and in which information indicating the operation screens displayed in the processing paths is annexed to corresponding ones of the links.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING(S)

FIG. 1 illustrates an outline of an embodiment;

FIG. 2 illustrates a system configuration of the embodiment;

FIG. 3 illustrates the hardware configuration of a business analysis apparatus;

FIG. 4 is a block diagram illustrating functions of the business analysis apparatus;

FIG. 5 illustrates an exemplary data structure of a schema table;

FIG. 6 exemplifies data tables managed by a database server;

FIG. 7 illustrates a first example of program information;

FIG. 8 illustrates a second example of program information;

FIG. 9 is a flowchart illustrating the procedure of a workflow diagram generation process;

FIG. 10 is a flowchart illustrating the procedure of an operational information extraction process;

FIG. 11 illustrates an exemplary data structure of an operational information table;

FIG. 12 illustrates an exemplary data structure of an operational information file;

FIG. 13 is a schematic diagram illustrating transition relations between data tables;

FIG. 14 is a flowchart illustrating the procedure of a path extraction process;

FIG. 15 illustrates an exemplary data structure of a path information table;

FIG. 16 is a flowchart illustrating the procedure of a group extraction process;

FIG. 17 illustrates an exemplary data structure of a screen group table;

FIG. 18 is a flowchart illustrating the procedure of a first path association process;

FIG. 19 exemplifies an operation screen displayed during the path association process;

FIG. 20 is a flowchart illustrating the procedure of a second path association process;

FIG. 21 is a flowchart illustrating the procedure of a third path association process;

FIG. 22 exemplifies a display screen displayed after the path association process;

FIG. 23 is a flowchart illustrating the procedure of a display position decision process;

FIG. 24 illustrates an exemplary data structure of a flow information file;

FIG. 25 illustrates a first display example of a workflow diagram;

FIG. 26 illustrates a second display example of the workflow diagram; and

FIG. 27 illustrates a third display example of the workflow diagram.

### DESCRIPTION OF EMBODIMENT(S)

Embodiments of the present invention will be described in detail below with reference to the accompanying drawings, wherein like reference numerals refer to like elements throughout. First, the present invention will be outlined, and then specific embodiments will be explained in detail.

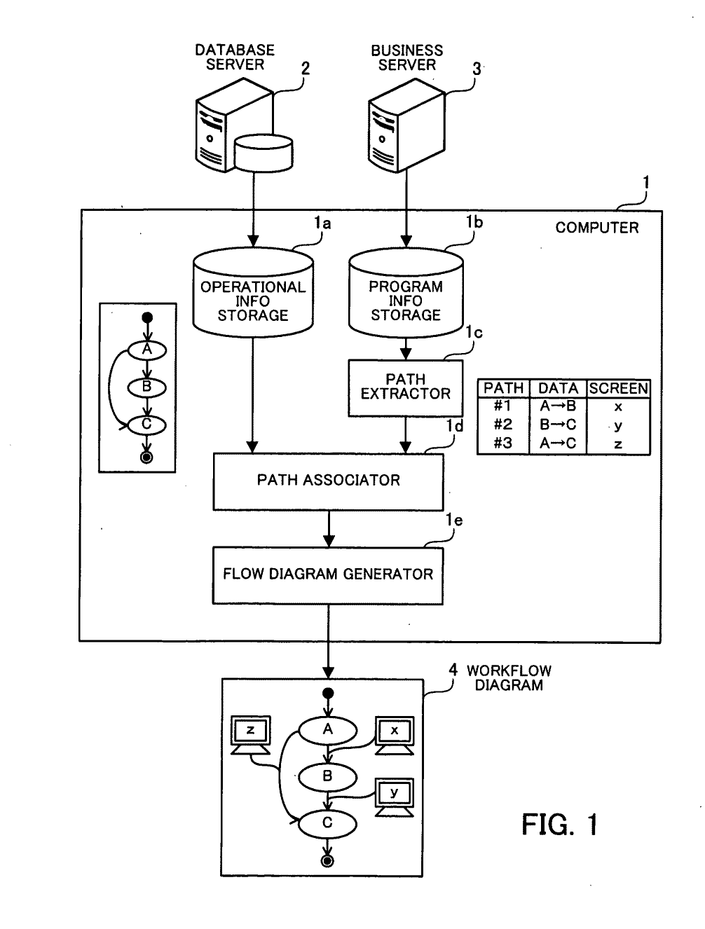

FIG. 1 illustrates an outline of an embodiment. A computer 1 illustrated in FIG. 1 generates a workflow diagram 4 on the basis of information indicating the update status of data sets managed by a database server 2 and information indicating a business program executed by a business server 3. The computer 1 comprises an operational information storage 1a, a program information storage 1b, a path extractor 1c, a path associator 1d, and a flow diagram generator 1e. These processing functions are performed, for example, by causing the computer 1 to execute a predetermined workflow diagram generation program.

The operational information storage 1a stores operational information indicating transition relations between data sets. The transition relation is a relation between two data sets successively updated by a business process during the operation of the database server 2. Namely, the operational information indicates the sequence of updating of the data sets during the operation.

The data set denotes a set of data defining one or more data items and managed by the database server 2. The data set is, for example, a data table in a relational database or a tree structure in an XML (extensive Markup Language) database. The business process is a series of actions executed with respect to a single business-related case, and includes an input operation performed on an operation screen displayed on the display device and data processing by the computer. For a single business process, data sets are updated a plurality of times.

The operational information can be acquired by continuously monitoring the data sets managed by the database server 2. Alternatively, the operational information may be obtained by analyzing an update log output from the database server 2. For example, suppose that data sets A, B and C are updated in the mentioned order in the course of a certain business process, and that the data sets A and C are updated in order in the course of a different business process. In this case, three transition relations indicating the transition from the data set A to the data set B, the transition from the data set B to the data set C, and the transition from the data set A to the data set C are generated as the operational information.

Also, the operational information may additionally include the start and end points of the business process, namely, information identifying the data set updated first and the data set updated last. In the above instance, the data sets A and C are the start and end points, respectively, in both business processes.

The program information storage 1b stores program information indicating the procedure of the business program. The business program is executed by the business server 3 to read and update the data sets managed by the database server 2. Also, the business program under execution displays an operation screen, whenever necessary, on a predetermined display device. One business process makes use of one or more business programs. Usually, multiple business programs are used to perform a single business process.

The description format of the program information is not particularly limited insofar as the procedure of the business program is described in the program information. Thus, the program information may be described, for example, in implementation code such as object code or source code, or may be design information such as a flowchart.

The path extractor 1c acquires the program information from the program information storage 1b and extracts a processing path. The processing path is a path that the process follows from the start of execution of the business program to the termination of same. In the case of a business program including conditional branching, paths following different branches are reckoned as different processing paths. Thus, in some cases, multiple processing paths are extracted from a single business program.

The path extractor 1c identifies a read process and an update process that are performed with respect to the data sets in the extracted processing path. Also, the path extractor 1c identifies an operation screen displayed in the course of the extracted processing path. The path extractor 1c then generates path information indicating the read process, the update process and the operation screen with respect to each processing path.

For example, the path extractor 1c generates information indicating that: a processing path #1 involves a read process of the data set A, an update process of the data set B and a display of an operation screen x; a processing path #2 involves a read process of the data set B, an update process of the data set C and a display of an operation screen y; and a processing path #3 involves a read process of the data set A, an update process of the data set C and a display of an operation screen z.

The path associator 1d acquires the operational information from the operational information storage 1a as well as the path information from the path extractor 1c. Then, based on the operational information and the path information, the path associator 1d associates the transition relations and the processing paths with each other. Specifically, the path associator 1d associates such a transition relation and a processing path with each other that the data set of a transition source in the transition relation agrees with the data set to be read in the processing path and also that the data set of a transition destination in the transition relation agrees with the data set to be updated in the processing path.

In the aforementioned instance, the transition relation of from the data set A to the data set B is associated with the processing path #1, the transition relation of from the data set B to the data set C is associated with the processing path #2, and the transition relation of from the data set A to the data set C is associated with the processing path #3.

The flow diagram generator 1e acquires the transition relation-processing path association results from the path associator 1d and generates a workflow diagram 4 based on the acquired association results. Specifically, first, the flow diagram generator 1e generates a digraph constituted by nodes, which represent the data sets, and links, which represent the transition relations. Each node is labeled the name of the corresponding data set, and each link is indicated by an arrow which starts from the node corresponding to the data set of the transition source and which points to the node corresponding to the data set of the transition destination.

Subsequently, if there is an operation screen to be displayed in the course of the processing path associated each link, the flow diagram generator 1e annexes information indicating the operation screen to the link. For example, the names of the operation screens are annexed to the corresponding links. Then, the flow diagram generator 1e outputs the workflow diagram 4 generated in this manner. The generated workflow diagram 4 may be presented to the user of the computer 1 to be further edited by the user.

With the computer 1 configured as described above, the path extractor 1c extracts processing paths from the program information indicating the procedure of the business program, and generates path information indicating read processes and update processes to be performed in the respective processing paths, as well as operation screens to be displayed in the processing paths. Subsequently, the path associator 1d associates each transition relation, which is the relation between two data sets successively updated during the operation, with a processing path of which the data set to be read agrees with the transition-source data set and of which the data set to be updated agrees with the transition-destination data set. Then, the flow diagram generator 1e generates a workflow diagram 4 which indicates the data sets as nodes and the transition relations as links and in which information indicating the operation screens to be displayed in the individual processing paths is annexed to the corresponding links.

It is therefore possible to promptly obtain a workflow diagram which appropriately reflects an actual workflow and also which indicates the operation screens to be displayed in individual steps of the workflow. Thus, the workflow diagram facilitates understanding of the positioning of individual works within the overall workflow.

An embodiment will be now described in detail with referent to the accompanying drawings.

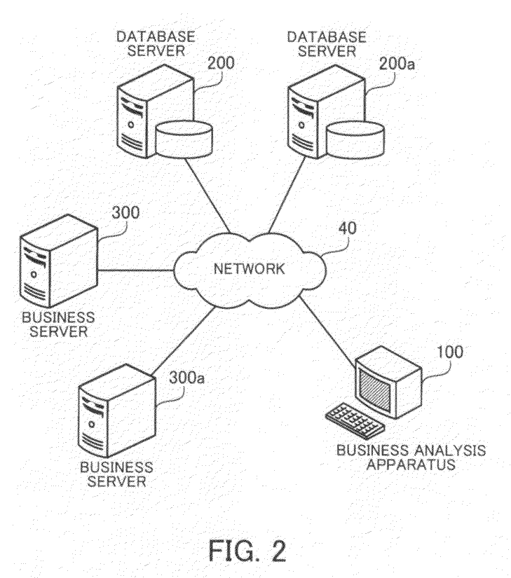

FIG. 2 illustrates a system configuration of the embodiment. A business analysis system illustrated in FIG. 2 analyzes data tables managed by a DBMS (DataBase Management System) to automatically generate a workflow diagram. The business analysis system according to the embodiment comprises a business analysis apparatus 100, database servers 200 and 200a, business servers 300 and 300a, and a network 40. The business analysis apparatus 100, the database servers 200 and 200a and the business servers 300 and 300a are connected to the network 40 and capable of communicating with one another.

The business analysis apparatus 100 is a computer for analyzing the workflow in response to the user's manipulated input and displaying a workflow diagram obtained as a result of the analysis. The business analysis apparatus 100 acquires, via the network 40, data tables managed by the database servers 200 and 200a, and then analyzes the acquired data tables to estimate the current workflow.

The database servers 200 and 200a are computers each of which executes a program for implementing the DBMS. The DBMS manages business data which is used by the business programs executed by the business servers 300 and 300a. Specifically, the DBMS manages the business data in the form of tables and retrieves and updates the business data at the request of the business programs.

The business servers 300 and 300a are computers for executing business programs specified by the user's manipulated input. Each of the business servers 300 and 300a executes a plurality of business programs. The business programs executed by the business servers 300 and 300a access the database servers 200 and 200a via the network 40, if necessary, to make use of the business data stored in the data tables. At this time, the business programs send an SQL (Structured Query Language) statement indicating the content of data manipulation to the DBMS.

In this embodiment, the business analysis apparatus 100 is provided as an apparatus for analyzing the workflow, but the function of the business analysis apparatus 100 may be performed by the database servers 200 and 200a. Also, the function of the business analysis apparatus 100 may be performed by the business servers 300 and 300a.

The hardware configuration of the business analysis apparatus 100, the database servers 200 and 200a and the business servers 300 and 300a will be now described.

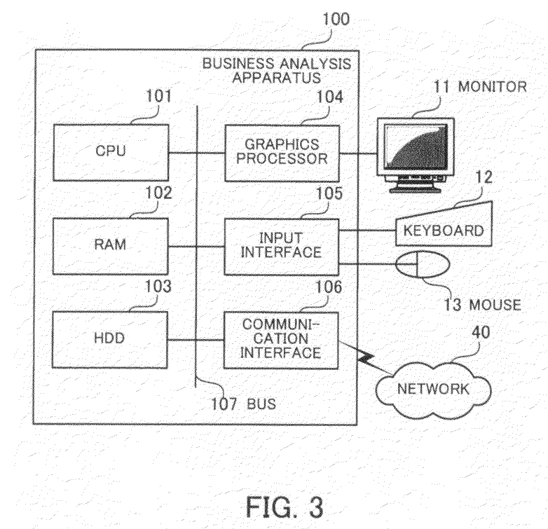

FIG. 3 illustrates the hardware configuration of the business analysis apparatus. The business analysis apparatus 100 operates under the control of a CPU (Central Processing Unit) 101. The CPU 101 is connected via a bus 107 with a RAM (Random Access Memory) 102, an HDD (Hard Disk Drive) 103, a graphics processor 104, an input interface 105, and a communication interface 106.

The RAM 102 temporarily stores at least part of OS (Operating System) and application programs executed by the CPU 101. Also, the RAM 102 temporarily stores at least part of various data necessary for the process of the CPU 101. The HDD 103 stores the OS and application programs. Also, the HDD 103 stores various data necessary for the process of the CPU 101.

The graphics processor 104 is connected with a monitor 11. In accordance with instructions from the CPU 101, the graphics processor 104 displays images on the screen of the monitor 11. The input interface 105 is connected with a keyboard 12 and a mouse 13, and sends signals from the keyboard 12 and the mouse 13 to the CPU 101 via the bus 107. The communication interface 106 is connected to the network 40.

The database servers 200 and 200a and the business servers 300 and 300a may each have a hardware configuration similar to that of the business analysis apparatus 100. With the hardware configuration described above, the processing function of the embodiment can be accomplished.

The following describes the module configuration of the business analysis apparatus 100.

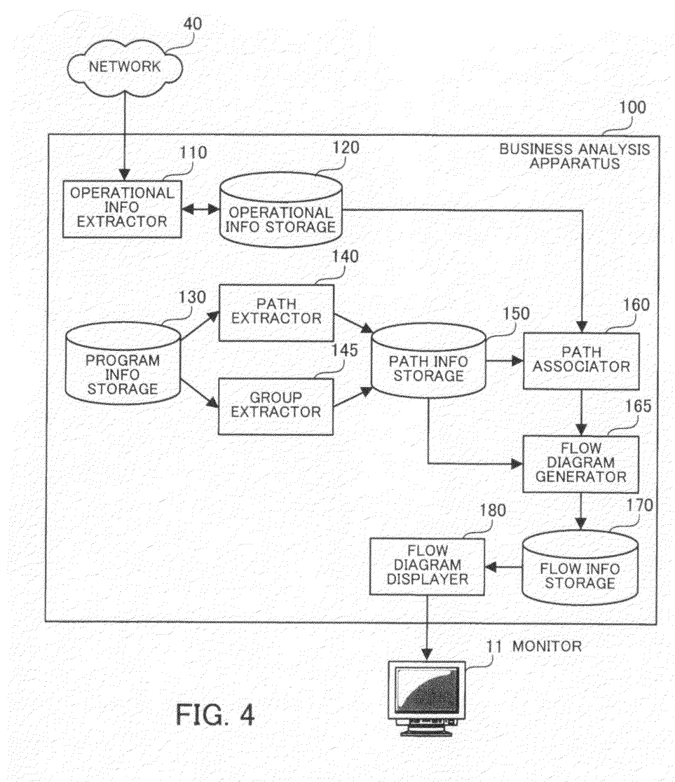

FIG. 4 is a block diagram illustrating functions of the business analysis apparatus. The business analysis apparatus 100 comprises an operational information extractor 110, an operational information storage 120, a program information storage 130, a path extractor 140, a group extractor 145, a path information storage 150, a path associator 160, a flow diagram generator 165, a flow information storage 170, and a flow diagram displayer 180.

The operational information extractor 110 acquires data tables from the database servers 200 and 200a via the network 40. Then, the operational information extractor 110 analyzes the acquired data tables and generates operational information. The operational information has described therein transition relations indicating the updating sequence of the data tables. The operational information extractor 110 specifies the transition relations by using, as clues, the timestamps included in records stored in the data tables.

The operational information storage 120 stores schema information defining the schema of the data tables managed by the database servers 200 and 200a. The schema information is looked up by the operational information extractor 110 and the path associator 160. Also, the operational information storage 120 stores the operational information generated by the operational information extractor 110.

The program information storage 130 has previously stored therein program information corresponding to the business programs executed by the business servers 300 and 300a. In the program information, the procedures of the business programs are described. The program information includes information indicating at least the read and update processes with respect to the data tables, display of operation screens, branching control, and function calls.

The path extractor 140 acquires the program information from the program information storage 130 and analyzes the acquired information to generate path information. The path information describes, with respect to each processing path included in the business programs, read and update processes with respect to the data tables, display of operation screens, and branching control executed in the course of the processing path.

The processing path is a single path that the process follows from the start to the termination of the business programs. Thus, a path following a different branch is judged a different processing path. In the case of a function call, a path in the called function is also continuously traced.

The group extractor 145 acquires the program information from the program information storage 130 and analyzes the acquired information to generate screen group information. The screen group information describes a screen group which is a set of operation screens that can be reached by continuously tracing one or more processing paths. Namely, all operation screens that can be reached as a result of continuous manipulation from a certain operation screen constitute the same screen group. Thus, two operation screens belonging to different processing paths may possibly constitute an identical screen group, and two operation screens belonging to different business programs may possibly constitute an identical screen group.

The path information storage 150 stores the path information generated by the path extractor 140. Also, the path information storage 150 stores the screen group information generated by the group extractor 145.

The path associator 160 acquires the operational information from the operational information storage 120 as well as the path information from the path information storage 150. Then, the path associator 160 associates the transition relations described in the operational information with the processing paths described in the path information. At this time, the path associator 160 accepts an input operation performed as needed by the user of the business analysis apparatus 100. Subsequently, the path associator 160 outputs the association results to the flow diagram generator 165.

Based on the association results output from the path associator 160, the flow diagram generator 165 identifies nodes and links that constitute a workflow diagram. Also, based on the screen group information stored in the path information storage 150, the flow diagram generator 165 divides the workflow diagram into lanes and decides the positioning of the individual nodes. At this time, the flow diagram generator 165 accepts an input operation performed as needed by the user of the business analysis apparatus 100. The flow diagram generator 165 then generates flow information representing the workflow diagram obtained in this manner.

The flow information storage 170 stores the flow information generated by the flow diagram generator 165.

The flow diagram displayer 180 acquires the flow information from the flow information storage 170 and displays the workflow diagram on the monitor 11.

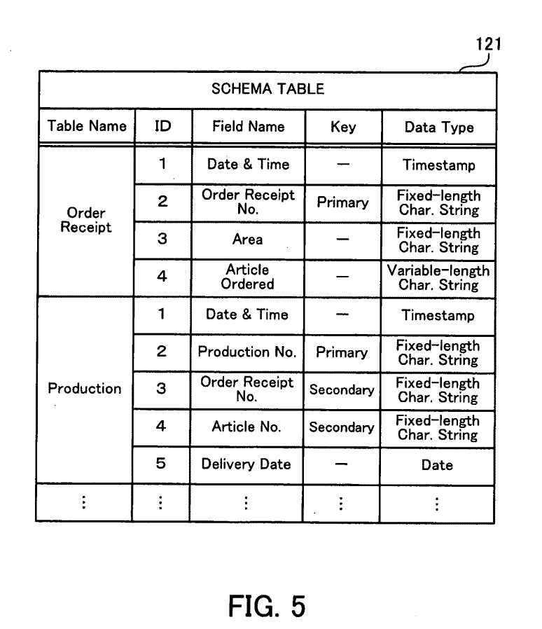

FIG. 5 illustrates an exemplary data structure of the schema table. The schema table 121 illustrated in FIG. 5 is stored in the operational information storage 120. The schema table 121 has columns indicating table name, ID, field name, key, and data type. The information items in each row are associated with one another and define a field.

The “Table Name” column specifies the names of the data tables managed by the database servers 200 and 200a. The “ID” column holds identification numbers uniquely identifying the respective fields in the individual data tables. The “Field Name” column specifies the names of the respective fields.

The “Key” column holds values indicating the key types assigned to the respective fields. Specifically, a primary key “Primary”, a secondary key “Secondary”, or no value “−” is set as the key. The primary key indicates a field which is used for uniquely identifying a record in the corresponding data table. The secondary key indicates a field other than the primary key and is used for identifying a record at the time of retrieval. The “Data Type” column specifies the types of values to be stored in the respective fields. For example, “Timestamp”, “Fixed-length Character String” and the like are specified.

The schema table 121 is created beforehand by the user of the business analysis apparatus 100 and is stored in the operational information storage 120. For example, information including “Order Receipt” as the table name, “2” as the ID, “Order Receipt No.” as the field name, “Primary” as the key, and “Fixed-length Character String” as the data type is registered in the schema table 121. The schema information to be registered in the schema table 121 can be created by using management information held by the DBMS of the database servers 200 and 200a.

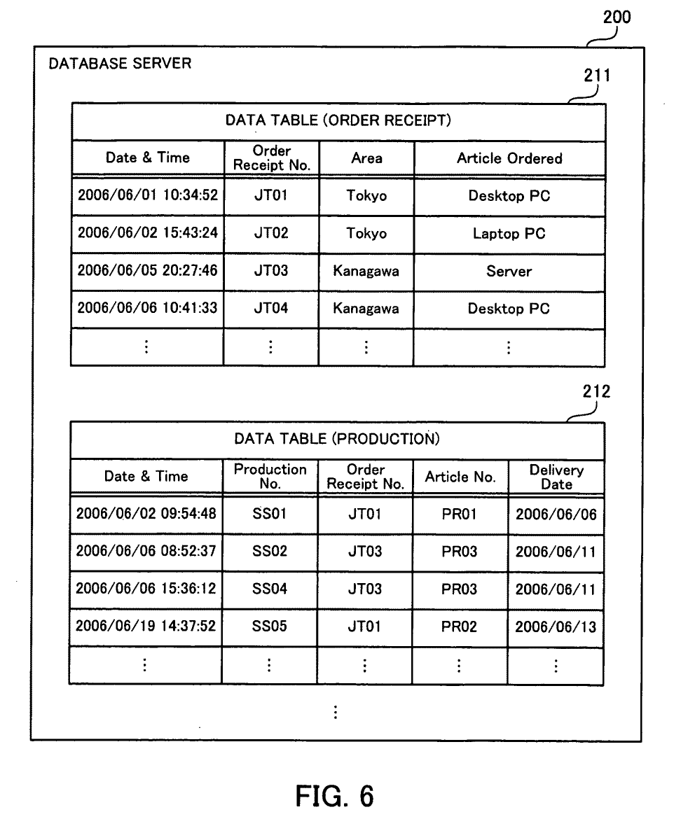

FIG. 6 exemplifies the data tables managed by the database servers. The data tables 211 and 212 illustrated in FIG. 6 are stored in the database server 200. The data table 211 has the table name “Order Receipt”, and the data table 212 has the table name “Production”.

The data table 211 has fields labeled “Date & Time”, “Order Receipt No.”, “Area” and “Article Ordered”, as specified in the schema table 121 illustrated in FIG. 5. The information items contained in each row of fields are associated with one another and constitute a record.

The “Date & Time” field holds, as a timestamp, the date and time at which the corresponding record was added or updated. The “Order Receipt No.” field contains identification information uniquely assigned to each order accepted. The “Area” field holds the name of a prefecture as the location of the ordering party. The “Article Ordered” field specifies the name of the ordered article. For example, a record including “2006/06/01 10:34:52” as the date and time, “JT01” as the order receipt number, “Tokyo” as the area, and “Desktop PC” as the ordered article is stored in the data table 211.

Similarly, the data table 212 has fields labeled “Date & Time”, “Production No.”, “Order Receipt No.”, “Article No.”, and “Delivery Date”. The information items contained in each row of fields are associated with one another and constitute a record.

The “Date & Time” field holds, as a timestamp, the date and time at which the corresponding record was added or updated. The “Production No.” field contains identification information uniquely assigned to an article produced. The “Order Receipt No.” field specifies the order receipt number corresponding to the article produced. The “Article No.” field holds identification information indicating the article number assigned to the article. The “Delivery Date” field specifies a date by which the article has to be delivered. For example, a record including “2006/06/02 09:54:48” as the date and time, “SS01” as the production number, “JT01” as the order receipt number, “PR01” as the article number, and “2006/06/06” as the delivery date is stored in the data table 212.

In this embodiment, it is assumed that each data table has timestamp fields indicating the dates and times at which the respective records were added or updated.

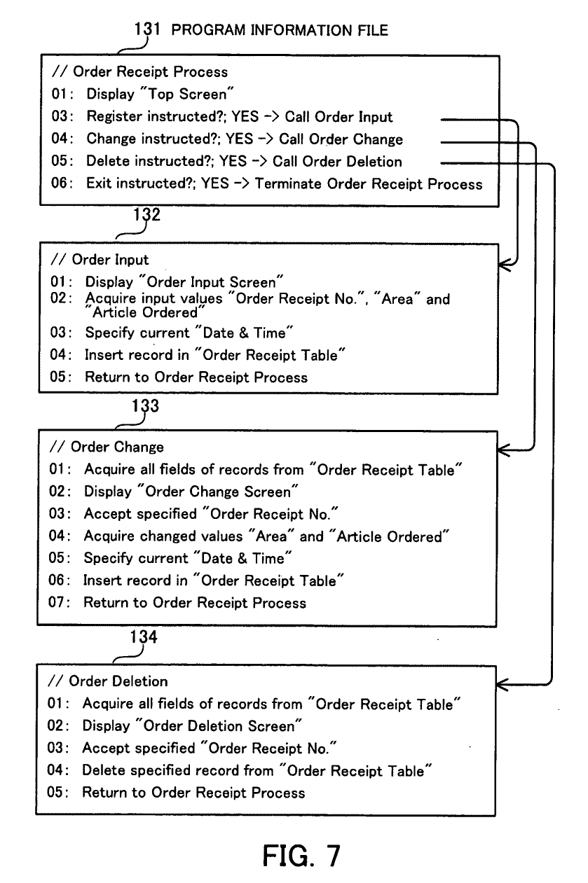

FIG. 7 illustrates a first example of the program information. Program information files 131 to 134 illustrated in FIG. 7 are stored in the program information storage 130. The program information file 131 describes a main program for executing an order receipt process. The program information file 132 describes a functional program for inputting an order, the program information file 133 describes a functional program for changing an order, and the program information file 134 describes a functional program for deleting an order.

These programs for the order receipt process, order input, order change and order deletion are executed by the business server 300. The main program is a business program called independently by a predetermined event that occurs during the course of work, and the functional program is a business program called by the main program or other functional program.

The order receipt processing program calls the order input program, the order change program, and the order deletion program whenever necessary. Specifically, the order receipt processing program first displays a top screen allowing the user's manipulated input. The order input program is called if a button “Register” is pressed, the order change program is called if a button “Change” is pressed, the order deletion program is called if a button “Delete” is pressed, and the process is terminated if a button “Exit” is pressed.

When called by the order receipt processing program, the order input program first displays an order input screen allowing the user's manipulated input. After the order receipt number, area and ordered article are entered, a record containing the entered items as well as the current date and time is added to the order receipt table. Control is then returned to the order receipt processing program.

The order change program, when called by the order receipt processing program, first acquires records from the order receipt table and displays an order change screen including a list of the records. With an order receipt number specified by the manipulated input, the area and/or the article is changed, whereupon a record containing the specified order receipt number, the entered items and the current date and time is added to the order receipt table. Control is then returned to the order receipt processing program.

When called by the order receipt processing program, the order deletion program first acquires records from the order receipt table and displays an order deletion screen including a list of the records. After an order receipt number is specified by the manipulated input, the order deletion program deletes the record identified by the specified order receipt number from the order receipt table. Control is then returned to the order receipt processing program.

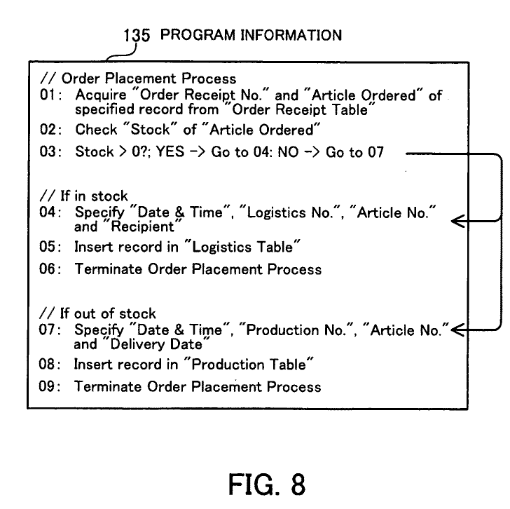

FIG. 8 illustrates a second example of the program information. A program information file 135 illustrated in FIG. 8 is stored in the program information storage 130. The program information file 135 describes a main program for executing an order placement process. The order placement processing program is executed by the business server 300.

The order placement processing program first acquires, from the order receipt table, the values of the order receipt number and ordered article, included in the record specified at the start of the program. Subsequently, the order placement processing program acquires a current stock amount of the ordered article from a system for performing stock management.

Then, the order placement processing program executes branching control using the following branch condition: whether the article is in stock or out of stock. If the article is in stock, the current date and time, a logistics number allocated to the article in stock, the article number and the recipient of the article are specified, and a record containing the specified items is added to a logistics table. On the other hand, if the article is out of stock, the current date and time, a production number allocated to an article to be produced, the article number and the delivery date are specified, and a record including the specified items is added to the production table.

The following describes details of a workflow diagram generation process executed by the business analysis apparatus 100 with the configuration and data structures described above. The workflow diagram generation process is executed when an analysis start instruction is input by the user of the business analysis apparatus 100.

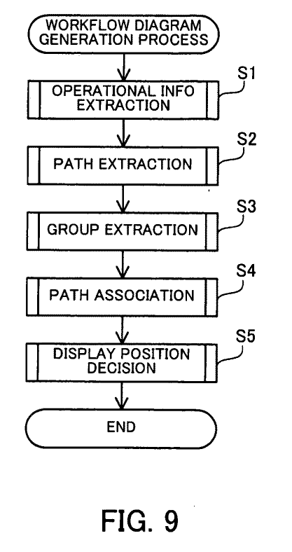

FIG. 9 is a flowchart illustrating the procedure of the workflow diagram generation process. In the following, the process illustrated in FIG. 9 will be explained in order of step number.

Step S1: The operational information extractor 110 acquires the data tables from the database servers 200 and 200a and analyzes the acquired data tables to generate operational information. Then, the operational information extractor 110 stores the generated operational information in the operational information storage 120.

Step S2: The path extractor 140 acquires the program information from the program information storage 130 and analyzes the acquired information to generate path information. The path extractor 140 then stores the generated path information in the path information storage 150.

Step S3: The group extractor 145 acquires the program information from the program information storage 130 and analyzes the acquired program information to generate screen group information. Then, the group extractor 145 stores the generated screen group information in the path information storage 150.

Step S4: The path associator 160 acquires the operational information from the operational information storage 120 as well as the path information from the path information storage 150, and associates the transition relations with the processing paths. Then, the path associator 160 notifies the flow diagram generator 165 of the association results.

Step S5: The flow diagram generator 165 acquires the association results from the path associator 160 and identifies nodes and links constituting a workflow diagram. Further, the flow diagram generator 165 acquires the screen group information from the path information storage 150 and determines how to arrange the individual nodes. The flow diagram generator 165 then generates flow information and stores the generated information in the flow information storage 170.

In the following, the operational information extraction process executed in Step S1, the path extraction process executed in Step S2, the group extraction process executed in Step S3, the path association process executed in Step S4, and the display position decision process executed in Step S5 will be explained in detail in the order mentioned.

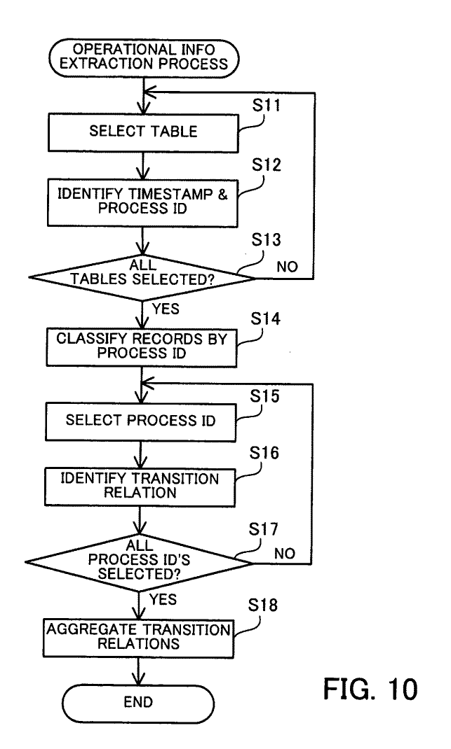

FIG. 10 is a flowchart illustrating the procedure of the operational information extraction process. The process illustrated in FIG. 10 will be explained below in order of step number.

Step S11: The operational information extractor 110 selects a data table not selected yet, from among the data tables managed by the database servers 200 and 200a.

Step S12: The operational information extractor 110 looks up the schema table 121 stored in the operational information storage 120 and identifies fields indicating timestamp and process ID, among the fields included in the data table selected in Step S11. Process ID fields hold identification information identifying individual business processes. In identifying such fields, the field names, key types and data types of the individual fields are taken into account.

Step S13: The operational information extractor 110 determines whether or not all data tables have been selected in Step S11. If all data tables have been selected, the process proceeds to Step S14; if there is a data table not selected yet, the process proceeds to Step S11.

Step S14: The operational information extractor 110 classifies all records in the data tables managed by the database servers 200 and 200a, according to the values of the process ID fields identified in Step S12.

Step S15: The operational information extractor 110 selects one process ID value not selected yet, from among those classified in Step S14.

Step S16: The operational information extractor 110 sorts records with the process ID value selected in Step S15, in ascending order of the value in the timestamp fields identified in Step S12. Namely, the records added or updated in the course of the execution of a certain business process are sorted in ascending order of the date and time. Then, based on the sorting results, the operational information extractor 110 identifies transition relations, each of which indicates the relation of updating sequence between two data tables. At this time, the operational information extractor 110 also identifies those fields in the two records which bear an identical value, namely, the fields between which a value is passed or inherited.

Step S17: The operational information extractor 110 determines whether or not all process IDs have been selected in Step S15. If all process IDs have been selected, the process proceeds to Step S18; if there is a process ID not selected yet, the process proceeds to Step S15.

Step S18: The operational information extractor 110 aggregates the transition relations, identified in Step S16, with respect to all process IDs. Then, the operational information extractor 110 generates operational information indicating the aggregated transition relations, and stores the generated information in the operational information storage 120.

In this manner, the operational information extractor 110 checks the individual data tables to identify the fields indicating the process ID and the timestamp. Then, by tracing records including a specific process ID in ascending order of the timestamp value, the operational information extractor 110 specifies the updating sequence between data tables. Also, the operational information extractor 110 identifies the field whose value is inherited from the data table as a transition source to the data table as a transition destination.

In Step S18, the operational information may be generated while excluding the transition relations of which the number of occurrences is smaller than a predetermined threshold. This makes it possible to generate a workflow diagram from which exceptional workflows that rarely occur have been excluded. Such a workflow diagram is especially useful for making an overall workflow easily understood.

For example, in the data tables 211 and 212 illustrated in FIG. 6, the “Order Receipt No.” field, which holds identification information set with respect to each business process, is identified as the process ID field, and the “Date & Time” field is identified as the timestamp field.

With respect to the two business processes with the order receipt numbers “JT01” and “JT03”, the production table is updated after the order receipt table is updated, and therefore, a transition relation of from the order receipt table to the production table is identified. At this time, the order receipt number fields are judged value-inherited fields. Also, with respect to the two business processes with the order receipt numbers “JT01” and “JT03”, the production table is again updated after the first updating. Accordingly, a transition relation of from the production table to the production table is identified.

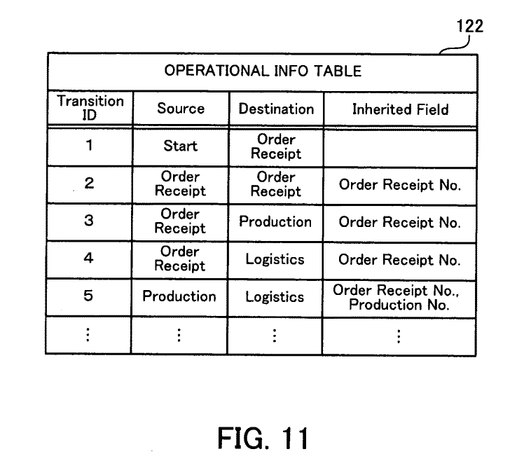

FIG. 11 illustrates an exemplary data structure of an operational information table. The operational information table 122 illustrated in FIG. 11 is stored in the operational information storage 120. The operational information table 122 has columns indicating transition ID, source of transition, destination of transition, and inherited field. The information items in each row are associated with one another and define a transition relation.

The “Transition ID” column holds identification numbers uniquely identifying the respective transition relations. The “Source” column specifies the names of data tables corresponding to the source of transition in the respective transition relations, and the “Destination” column specifies the names of data tables corresponding to the destination of transition in the respective transition relations. The “Inherited Field” column holds the names of fields whose value is passed, or inherited, from the transition-source table to the transition-destination table.

The first updating of a business process is expressed by setting “Start” under the “Source” column and setting, under the “Destination” column, the name of the data table updated first. Also, the last updating of a business process is expressed by setting, under the “Source” column, the name of the data table updated last and setting “End” under the “Destination” column.

The operational information table 122 is generated by the operational information extractor 110. For example, information including “3” as the transition ID, “Order Receipt” as the source of transition, “Production” as the destination of transition, and “Order Receipt No.” as the inherited field is stored in the operational information table 122. This information indicates that a business process was executed in the past in which the order receipt table was updated followed by the updating of the production table.

In FIG. 11, the operational information is represented in tabular form but may be represented in some other form. For example, the operational information may be described as a text document.

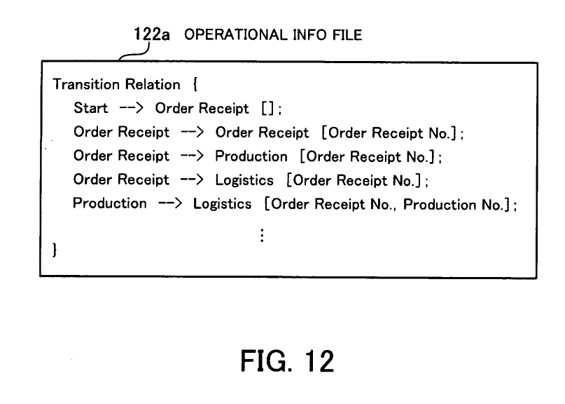

FIG. 12 illustrates an exemplary data structure of such an operational information file. Instead of the operational information table 122 illustrated in FIG. 11, the operational information file 122a illustrated in FIG. 12 may be stored in the operational information storage 120.

In the operational information file 122a, one line of text defines one transition relation. Also, in the operational information file 122a, the name of the transition-source data table is indicated to the left of the arrow, and the name of the transition-destination data table is indicated to the right of the arrow. The name of the inherited field is enclosed in brackets ([ ]). Describing the operational information in text format makes it easy to edit the operational information manually after the generation.

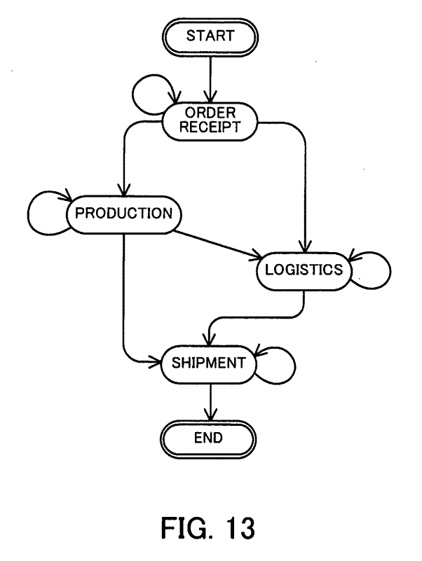

FIG. 13 is a schematic diagram illustrating the transition relations between data tables. The digraph of FIG. 13 is a visual representation indicating what is meant by the operational information illustrated in FIGS. 11 and 12. The nodes except the start and end nodes correspond to the respective data tables, and the links correspond to the respective transition relations. By tracing the link from the start node toward the end node, it is possible to identify the sequence of updating of the data tables in the business processes executed in the past.

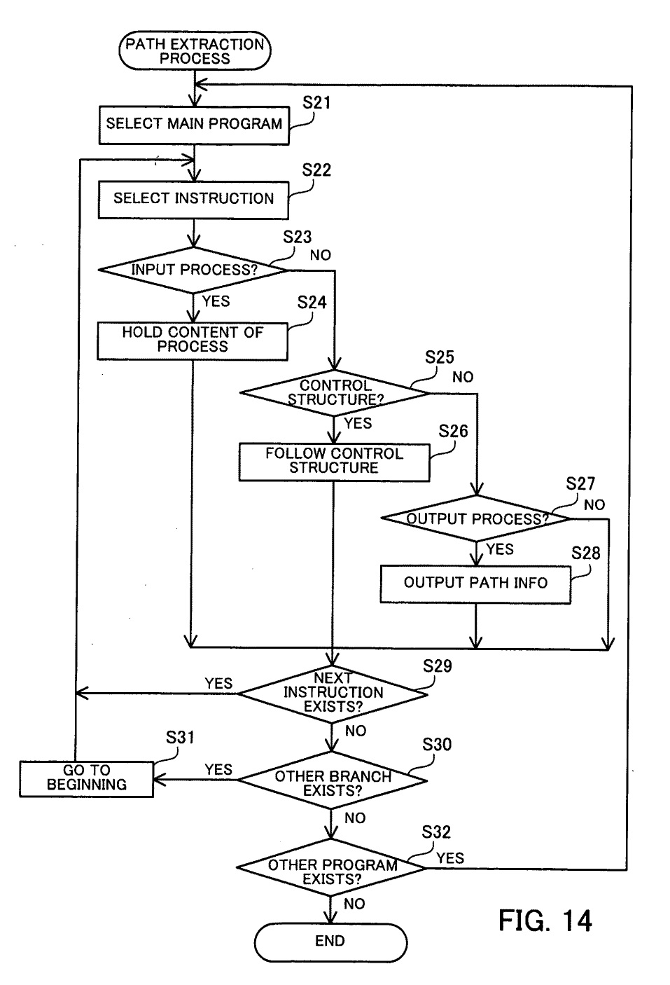

FIG. 14 is a flowchart illustrating the procedure of the path extraction process. In the following, the process illustrated in FIG. 14 will be explained in order of step number.

Step S21: The path extractor 140 selects a main program not selected yet, from among the program information stored in the program information storage 130. Then, the path extractor 140 analyzes the syntax of the selected program information to identify the order relations of individual steps.

Step S22: The path extractor 140 selects one instruction in order of execution, from among those included in the program information selected in Step S21.

Step S23: The path extractor 140 determines whether or not the instruction selected in Step S22 is related to input process. The input process is a process of reading records from a data table or a process of accepting input values from an operation screen. If the instruction is related to the input process, the process proceeds to Step S24; if not, the process proceeds to Step S25.

Step S24: The path extractor 140 holds information about the input process. Specifically, in the case of the process of reading records from a data table, the path extractor 140 holds the name of the data table to be read and the names of fields to be read. In the case of the process of accepting input values from an operation screen, the path extractor 140 holds the name of the operation screen and the names of input fields. The process thereafter proceeds to Step S29.

Step S25: The path extractor 140 determines whether or not the instruction selected in Step S22 is related to control structure. A control structure-related instruction is a function call instruction or a branching instruction. If the instruction is related to the control structure, the process proceeds to Step S26; if not, the process proceeds to Step S27.

Step S26: The path extractor 140 traces the path in accordance with the control structure. Specifically, where the instruction is a function call, the path extractor 140 analyzes the syntax of the program information associated with the called functional program, and makes a jump to the beginning of the functional program. In the case of a branching instruction, the path extractor 140 holds the branch condition and selects an unselected branch to trace the path. The process thereafter proceeds to Step S29.

Step S27: The path extractor 140 determines whether or not the instruction selected in Step S22 is related to output process. The output process is a process for updating a data table, that is, a process of adding, updating or deleting a record. If the instruction is related to the output process, the process proceeds to Step S28; if not, the process proceeds to Step S29.

Step S28: The path extractor 140 identifies information related to the output process. Specifically, the path extractor 140 identifies the name of the data table to be updated, the type of update process to be performed on the data table (addition or updating or deletion of a record), and the names of fields to be written. Also, the path extractor 140 specifies the name of an inherited field, that is, the name of a field whose value is acquired in the input process and is used in the output process. Then, the path extractor 140 generates path information including the information about the input process and branching control held thereby and the information about the output process identified thereby, and stores the generated path information in the path information storage 150. The held information is thereafter discarded, whereupon the process proceeds to Step S29.

Step S29: The path extractor 140 determines whether or not there is an instruction to be selected next in order of execution. Namely, it is determined whether or not the currently traced path has reached the end of the business program. If there is an instruction to be selected next, the process proceeds to Step S22; if not, the process proceeds to Step S30.

Step S30: The path extractor 140 determines whether or not there is a branch path not selected yet in Step S26. Namely, it is determined whether or not there is another processing path in the main program selected in Step S21. If there is a branch path not selected yet, the process proceeds to Step S31; if there is no unselected branch path, the process proceeds to Step S32.

Step S31: The path extractor 140 returns to the beginning of the main program selected in Step S21, and then the process proceeds to Step S22.

Step S32: The path extractor 140 determines whether or not there is a main program not selected yet in Step S21. If there is a main program not selected yet, the process proceeds to Step S21; if all main programs have been selected, the path extraction process ends.

In this manner, the path extractor 140 acquires instructions successively from the beginning of each main program and holds the contents of instructions related to the input process and the branching control. When an instruction related to the output process is found, the path traced after the immediately preceding output process is reckoned a processing path and is output as path information. That is, the update process with respect to a data table is necessarily executed once per processing path, whereas the read process with respect to a data table, the acceptance of input values from an operation screen, and the branching control are executed as many times as needed per processing path.

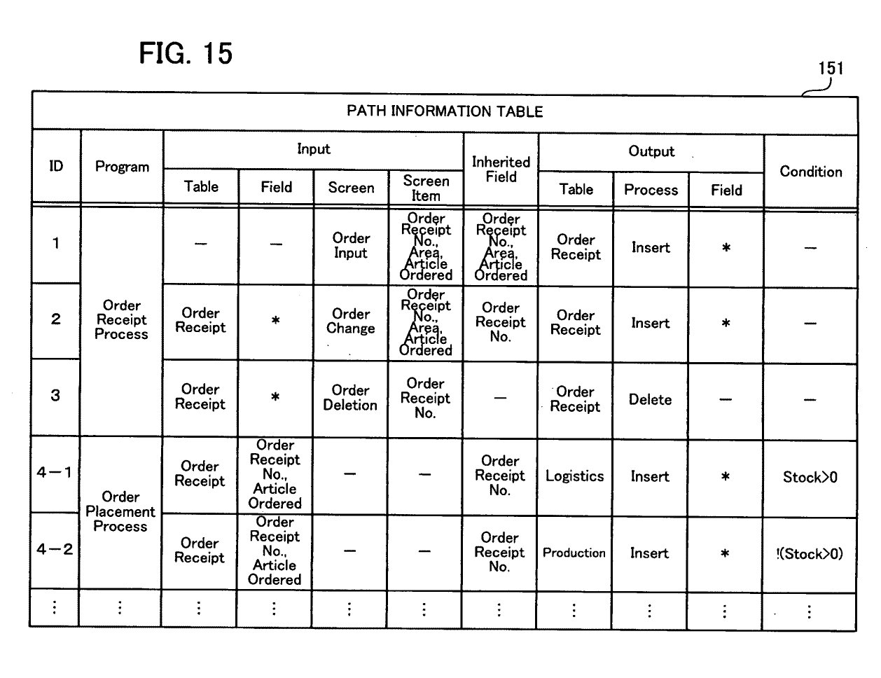

FIG. 15 illustrates an exemplary data structure of a path information table. The path information table 151 illustrated in FIG. 15 is stored in the path information storage 150. The path information table 151 has columns indicating ID, program, input table, input field, input screen, input screen item, inherited field, output table, output process, output field, and condition. The information items in each row are associated with one another and constitute path information about one processing path.

The “% ID” column holds identification information uniquely identifying the individual processing paths. The “Program” column holds the names of the main programs to which the start points of the respective processing paths belong. The input table column holds the names of the data tables to be read. The input field column holds the names of the fields to be read. Where all fields included in the data table are to be read, however, “*” is set instead of the field names. The input screen column holds the names of operation screens permitting the input of values. The input screen item column holds the names of items that can be input via the respective operation screens. The “Inherited Field” column holds the names of fields or items of which the value is inherited from the data table to be read or from the input operation screen to the data table to be updated.

The output table column specifies the names of the data tables to be updated. The output process column specifies the types of update process. Specifically, “INSERT” indicating the addition of a record, “UPDATE” indicating the updating of a record, or “DELETE” indicating the deletion of a record is set. The output field column holds the names of the fields to be written. Where all fields included in the data table are to be written, however, “*” is set in place of the field names. The “Condition” column specifies the contents of branch conditions used in the branching control.

The path information table 151 is generated by the path extractor 140. For example, information including “4-1” as the ID, “Order Placement Process” as the program, “Order Receipt” as the input table, “Order Receipt No.” and “Article Ordered” as the input fields, “Order Receipt No.” as the inherited field, “Logistics” as the output table, “INSERT” as the output process, “*” as the output fields, and “Stock>0” as the condition is generated and stored. This information corresponds to the processing path followed when the article is judged to be in stock in the order placement processing program illustrated in FIG. 8.

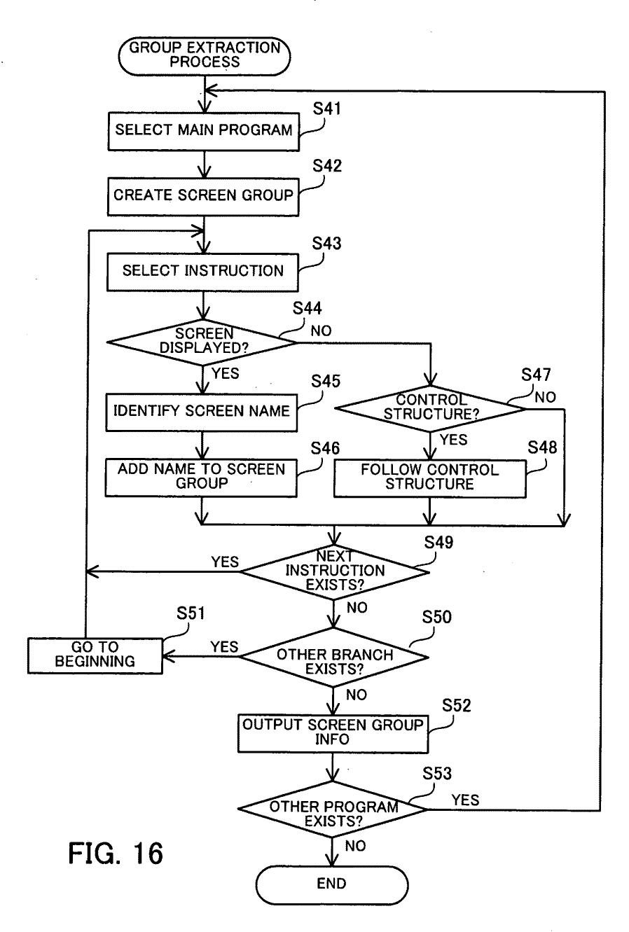

FIG. 16 is a flowchart illustrating the group extraction process. In the following, the process illustrated in FIG. 16 will be explained in order of step number.

Step S41: The group extractor 145 selects a main program not selected yet, from among the program information stored in the program information storage 130. Then, the group extractor 145 analyzes the syntax of the selected program information to identify the order relations of individual steps.

Step S42: The group extractor 145 creates a new screen group. In the initial state, the created screen group is an empty set.

Step S43: The group extractor 145 selects one instruction in order of execution, from among those included in the program information selected in Step S41.

Step S44: The group extractor 145 determines whether or not the instruction selected in Step S43 is related to an operation screen. If the instruction is related to an operation screen, the process proceeds to Step S45; if not, the process proceeds to Step S47.

Step S45: The group extractor 145 identifies the name of the operation screen.

Step S46: If the name of the operation screen identified in Step S45 is not included in the screen group created in Step S42, the group extractor 145 includes the identified name of the operation screen in the screen group. The process thereafter proceeds to Step S49.

Step S47: The group extractor 145 determines whether or not the instruction selected in Step S43 is related to the control structure. If the instruction is related to the control structure, the process proceeds to Step S48; if not, the process proceeds to Step S49.

Step S48: The group extractor 145 traces the path in accordance with the control structure. Specifically, where the instruction is a function call, the group extractor 145 analyzes the syntax of the program information of the called functional program, and makes a jump to the beginning of the functional program. In the case of a branching instruction, the group extractor 145 holds the branch condition and selects an unselected branch to trace the path. The process thereafter proceeds to Step S49.

Step S49: The group extractor 145 determines whether or not there is an instruction to be selected next in order of execution. If there is an instruction to be selected next, the process proceeds to Step S43; if not, the process proceeds to Step S50.

Step S50: The group extractor 145 determines whether or not there is a branch path not selected yet in Step S48. If there is a branch path not selected yet, the process proceeds to Step S51; if there is no unselected branch path, the process proceeds to Step S52.

Step S51: The group extractor 145 returns to the beginning of the main program selected in Step S41, and the process then proceeds to Step S43.

Step S52: The group extractor 145 generates screen group information, which is a list of the operation screen names included in the screen group, and stores the generated information in the path information storage 150. Then, the group extractor 145 discards the screen group created in Step S42.

Step S53: The group extractor 145 determines whether or not there is a main program not selected yet in Step S41. If there is a main program not selected yet, the process proceeds to Step S41; if all main programs have been selected, the group extraction process ends.

In this manner, the group extractor 145 continuously follows the path, regardless of whether the path traced involves multiple processing paths or not, and regards a set of reachable operation screens as the screen group. The group extractor 145 then generates screen group information and stores the generated information in the path information storage 150.

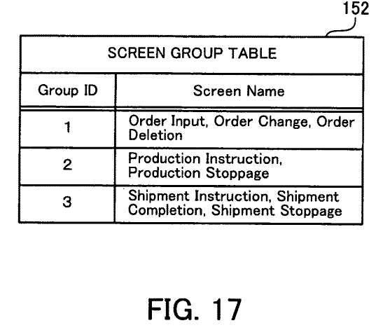

FIG. 17 illustrates an exemplary data structure of a screen group table. The screen group table 152 illustrated in FIG. 17 is stored in the path information storage 150. The screen group table 152 has columns indicating group ID and screen name. The information items in each row are associated with each other and define a screen group.

The “Group ID” column holds identification numbers uniquely identifying the respective screen groups. The “Screen Name” column holds lists of operation screen names belonging to the respective screen groups. The screen group table 152 is generated by the group extractor 145.

For example, information including “1” as the group ID and “Order Input, Order Change, Order Deletion” as the screen names is generated and stored. This information indicates that the order input screen, the order change screen and the order deletion screen are the operation screens that can be reached by continuously tracing the path, as seen from FIG. 7. The top screen displayed by the order receipt processing program is not extracted because it is not a screen allowing the input of values.

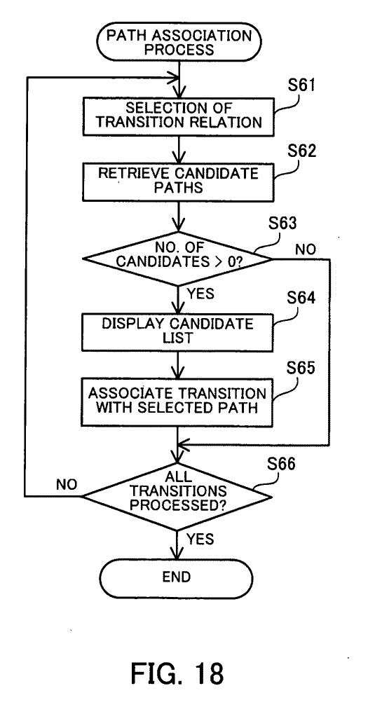

FIG. 18 is a flowchart illustrating the procedure of a first path association process. In the following, the process illustrated in FIG. 18 will be explained in order of step number.

Step S61: The path associator 160 displays a digraph, such as the one illustrated in FIG. 13, on the basis of the operational information table 122 stored in the operational information storage 120, and prompts the user to select one transition relation.

Step S62: The path associator 160 searches the path information table 151 stored in the path information storage 150 and extracts candidate processing paths matching the transition relation selected by the user in Step S61. Specifically, the path associator 160 extracts, as candidates for association, all processing paths of which the data table to be read agrees with the transition-source data table specified by the transition relation and of which the data table to be updated agrees with the transition-destination data table specified by the transition relation.

Step S63: The path associator 160 determines whether or not the number of the candidate processing paths extracted in Step S62 is greater than “0”. If one or more candidates have been extracted, the process proceeds to Step S64; if no candidate has been extracted, the process proceeds to Step S66.

Step S64: The path associator 160 displays a list of the path information about the processing paths extracted in Step S62, and prompts the user to select one processing path.

Step S65: The path associator 160 associates the processing path selected by the user in Step S64 with the transition relation selected in Step S61.

Step S66: The path associator 160 determines whether or not all transition relations have been selected in Step S61. If all transition relations have been selected, the path association process ends; if there is an unselected transition relation, the process proceeds to Step S61.

In this manner, each time a transition relation is selected by the user, the path associator 160 extracts and displays candidate processing paths to be associated. Then, the path associator 160 associates the processing path selected by the user from among the candidates with the transition relation.

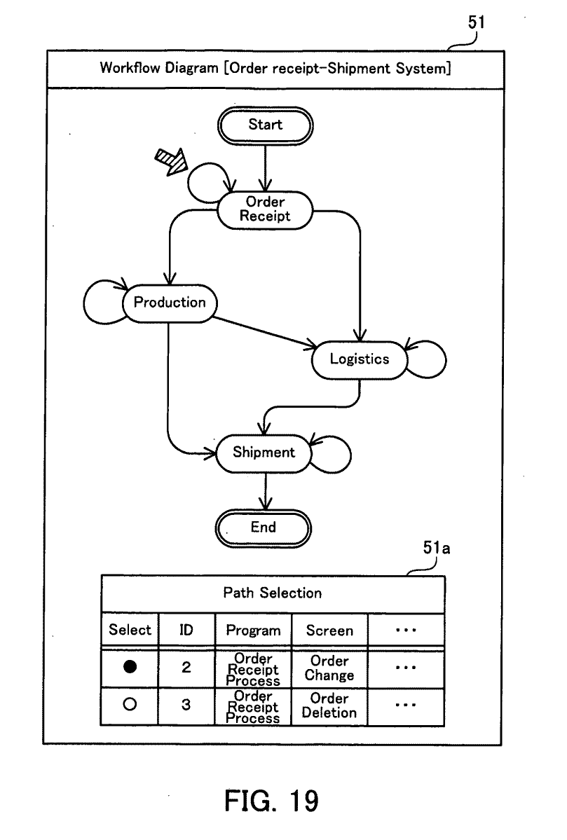

FIG. 19 exemplifies an operation screen displayed during the path association process. The screen 51 illustrated in FIG. 19 is displayed by the path associator 160. The screen 51 includes a digraph visually representing the transition relations between the data tables. When a transition relation is selected by the user, candidate processing paths matching the selected transition relation are displayed in an area 51a within the screen 51. Thus, the user can select a processing path from among those displayed in the area 51a.

For example, suppose that the transition relation of from the order receipt table to the order receipt table is selected by the user. In this case, the path associator 160 searches the path information table 151 illustrated in FIG. 15 and extracts the path information about the processing paths of which the input and output table names are both “Order Receipt”. Specifically, the path information with the ID “2” and the path information with the ID “3” are extracted. At this time, various information stored in the path information table 151 is displayed in the area 51a, and therefore, using the displayed items as clues, the user can determine a proper processing path, namely, a processing path that is thought to be used in actual work.

In the path association process illustrated in FIG. 18, the transition relations are selected one by one by the user. The path associator 160 also provides other methods for the path association. The user of the business analysis apparatus 100 is allowed to specify a path association method to be used by the path associator 160. The following explains two other examples of the path association process.

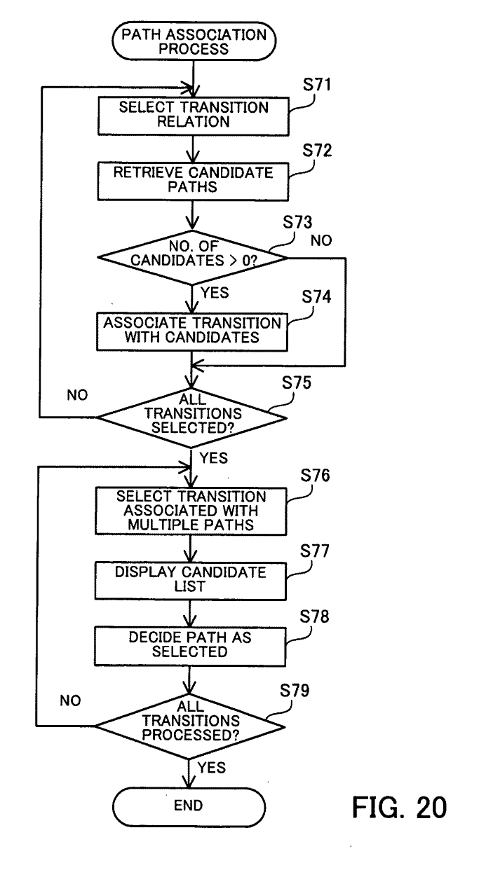

FIG. 20 is a flowchart illustrating the procedure of a second path association process. In the following, the process illustrated in FIG. 20 will be explained in order of step number.

Step S71: The path associator 160 selects one transition relation on the basis of the operational information table 122 stored in the operational information storage 120.

Step S72: The path associator 160 searches the path information table 151 stored in the path information storage 150, by using the names of the data tables as the search condition, and extracts all candidate processing paths matching the transition relation selected in Step S71.

Step S73: The path associator 160 determines whether or not the number of the candidate processing paths extracted in Step S72 is greater than “0”. If one or more candidates have been extracted, the process proceeds to Step S74; if no candidate has been extracted, the process proceeds to Step S75.

Step S74: The path associator 160 associates all of the candidate processing paths extracted in Step S72 with the transition relation selected in Step S71.

Step S75: The path associator 160 determines whether or not all transition relations have been selected in Step S71. If all transition relations have been selected, the process proceeds to Step S76; if there is a transition relation not selected yet, the process proceeds to Step S71.

Step S76: The path associator 160 selects one of the transition relations associated with multiple candidate processing paths.

Step S77: The path associator 160 displays a list of the path information about the candidate processing paths and prompts the user to select one processing path.

Step S78: The path associator 160 decides that the processing path selected by the user in Step S77 shall be the processing path associated with the transition relation selected in Step S71.

Step S79: The path associator 160 determines whether or not all of the transition relations associated with multiple candidate processing paths have been selected in Step S76. If all of the transition relations have been selected, the path association process ends; if there is a transition relation not selected yet, the process proceeds to Step S76.

In this manner, the path associator 160 provisionally associates each transition relation with candidate processing paths. Only with respect to the transition relations associated with multiple candidates, the user is prompted to select a processing path to be actually associated, whereby the user's burden accompanying the manipulation can be mitigated.

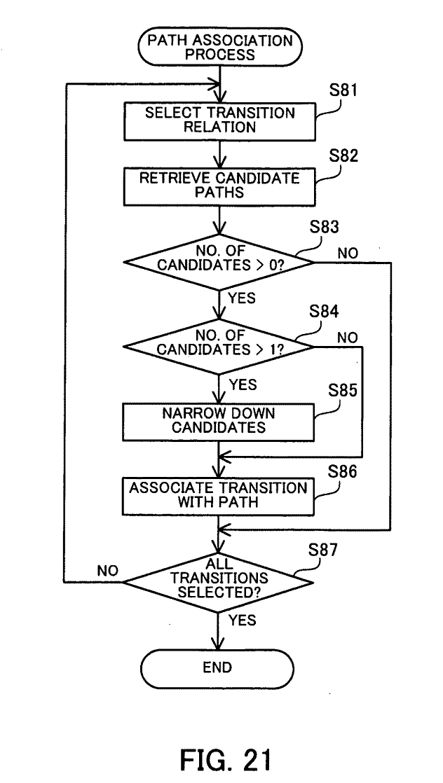

FIG. 21 is a flowchart illustrating the procedure of a third path association process. In the following, the process illustrated in FIG. 21 will be described in order of step number.

Step S81: The path associator 160 selects one transition relation on the basis of the operational information table 122 stored in the operational information storage 120.

Step S82: The path associator 160 searches the path information table 151 stored in the path information storage 150, by using the names of the data tables as the search condition, and extracts all candidate processing paths matching the transition relation selected in Step S81.

Step S83: The path associator 160 determines whether or not the number of the candidate processing paths extracted in Step S82 is greater than “0”. If one or more candidates have been extracted, the process proceeds to Step S84; if no candidate has been extracted, the process proceeds to Step S87.

Step S84: The path associator 160 determines whether or not the number of the candidate processing paths extracted in Step S82 is greater than “1”. If two or more candidates have been extracted, the process proceeds to Step S85; if only one candidate has been extracted, the process proceeds to Step S86.

Step S85: Using the inherited field as a condition, the path associator 160 narrows down the candidate processing paths extracted in Step S82. Specifically, the path associator 160 selects a processing path of which the inherited field agrees with that specified in the transition relation.

Step S86: Where only one candidate processing path has been extracted in Step S82, the path associator 160 associates this processing path with the transition relation selected in Step S81, and where a plurality of candidate processing paths have been extracted, the path associator 160 associates the processing path obtained by narrowing down the candidates in Step S85 with the transition relation.

Step S87: The path associator 160 determines whether or not all transition relations have been selected in Step S81. If all transition relations have been selected, the path association process ends; if there is a transition relation not selected yet, the process proceeds to Step S81.

In this manner, for a transition relation with respect to which only one candidate processing path exists, the path associator 160 associates the only one processing path with the transition relation, and for a transition relation with respect to which a plurality of candidate processing paths exist, the path associator 160 narrows down the candidates by using the inherited field and associates the processing path obtained as a result with the transition relation. It is therefore possible to automatically associate all of the transition relations with processing paths, whereby the user's burden associated with the manipulation can be further lessened.

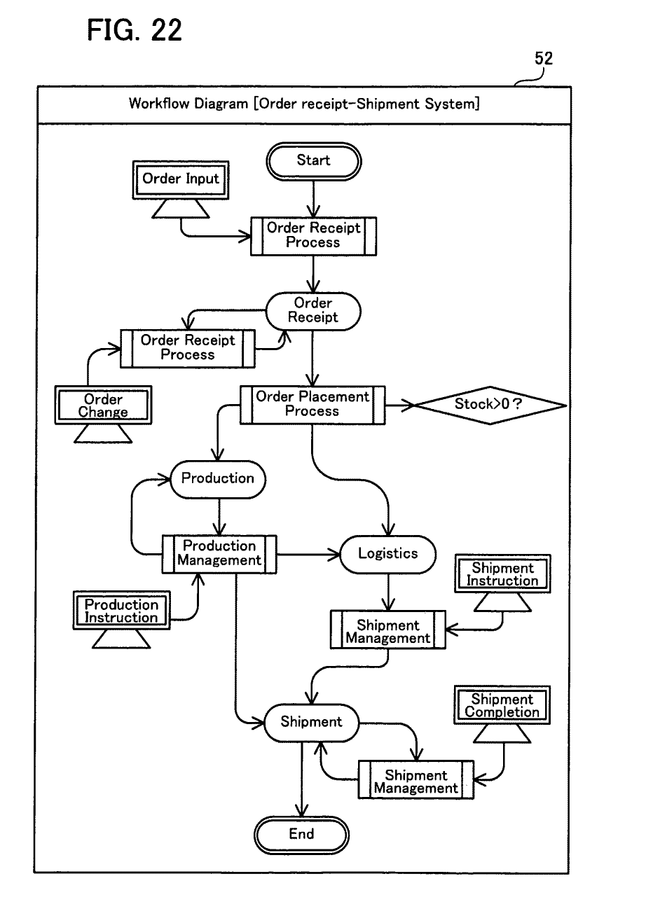

FIG. 22 exemplifies a screen displayed after the path association process. The screen 52 illustrated in FIG. 22 is displayed immediately after the flow diagram generator 165 is notified of the association results from the path associator 160 following the completion of the path association process illustrated in FIG. 18, 20 or 21. The screen 52 includes a digraph visually representing the relationship between the data tables, the business programs, the operation screens, and the branch condition.

The digraph in the screen 52 depicts nodes corresponding to the data tables and links corresponding to the transition relations, and nodes corresponding to the business programs are inserted in the middle of the respective links. Also, nodes corresponding to the operation screens and a node indicating the branch condition are connected to corresponding ones of the business program nodes. Where an identical business program node needs to be inserted in multiple links extending from one data table node, the business program nodes and the links are put together, instead of inserting the business program node in each of the links. This makes it easier to understand the digraph.

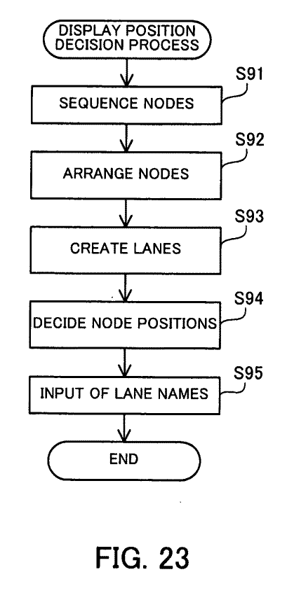

FIG. 23 is a flowchart illustrating the procedure of the display position decision process. In the following, the process illustrated in FIG. 23 will be described in order of step number.

Step S91: Based on the association results received from the path associator 160, the flow diagram generator 165 specifies nodes and links to be depicted in the workflow diagram. Then, the flow diagram generator 165 sequences the data table nodes. In this case, the nodes are sequenced in order of the closeness to the start node.

Step S92: The flow diagram generator 165 arranges the data table nodes in a predetermined direction in the order determined in Step S91, and decides the position of the individual data table nodes. For example, the flow diagram generator 165 lines up the data table nodes in a direction from the upper left corer of the display area to the lower right corner of same. Where the direction of arranging the nodes is expressly designated by the user of the business analysis apparatus 100, the nodes are arranged in the designated direction.

Step S93: The flow diagram generator 165 creates lanes such that their borderlines pass through the respective data table nodes. For example, where the data table nodes are lined up in the direction from the upper left corner to the lower right corner of the display area in Step S92, vertically long lanes are created.

Step S94: The flow diagram generator 165 acquires the screen group information from the screen group table 152 stored in the path information storage 150. Then, the flow diagram generator 165 decides the position of the individual business program nodes and operation screen nodes such that the operation screen nodes belonging to an identical screen group are contained in the same lane. Also, the flow diagram generator 165 decides the position of the branch condition node so as to be located close to the corresponding business program node.

Step S95: The flow diagram generator 165 displays the workflow diagram generated by the execution of Steps S91 through S94, and prompts the user to input the names of the individual lanes. The flow diagram generator 165 then associates the input lane names with the respective lanes. Subsequently, the flow diagram generator 165 generates flow information indicating the obtained workflow diagram, and stores the generated information in the flow information storage 170.

In this manner, the flow diagram generator 165 sequences and arranges the data table nodes and also creates lanes such that the data table nodes are located on the borders of the respective lanes. Then, the flow diagram generator 165 decides the positioning of the business program nodes and operation screen nodes such that the operation screen nodes belonging to an identical screen group are situated in the same lane. Consequently, nodes indicating a series of operations are displayed within an identical lane.

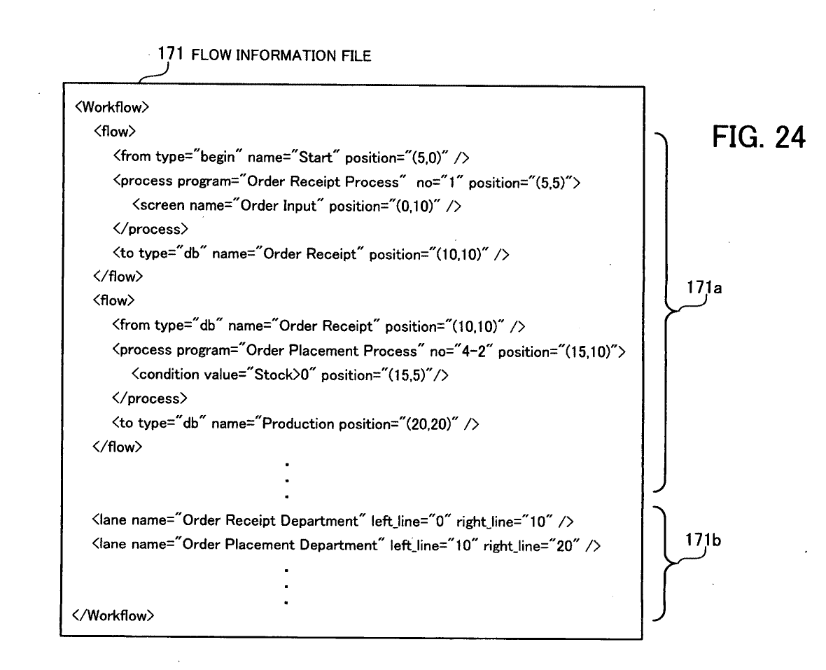

FIG. 24 illustrates an exemplary data structure of a flow information file. The flow information file 171 illustrated in FIG. 24 is stored in the flow information storage 170. In the flow information file 171, the flow information is described in XML format. The flow information file 171 comprises two sections, namely, a section 171a describing the individual nodes and links constituting the workflow diagram, and a section 171b describing the lanes.

In the section 171a, one transition relation is described using a flow-tag. In the flow-tag, a from-tag, a process-tag and a to-tag are described as subelements. Further, where necessary, a screen-tag and a condition-tag are described as subelements of the process-tag.

The from-tag has set therein an attribute indicating the name of the transition-source data table as well as an attribute indicating the node position. The process-tag has set therein an attribute indicating the name of the business program, an attribute indicating the identification information of the transition relation, and an attribute indicating the node position. The to-tag has set therein an attribute indicating the name of the transition-destination data table and an attribute indicating the node position. The screen-tag has set therein an attribute indicating the name of the operation screen and an attribute indicating the node position. The condition-tag has set therein an attribute indicating the branch condition and an attribute indicating the node position.

In the section 171b, each lane is described using a lane-tag. The lane-tag has set therein an attribute indicating the name of the lane, an attribute indicating the position of the left-hand boundary of the lane, and an attribute indicating the position of the right-hand boundary of the lane. The lanes are defined as such in the case where vertically long lanes have been set. In the case of horizontally long lanes, attributes indicating the positions of the upper and lower boundaries, respectively, are described in each lane-tag.

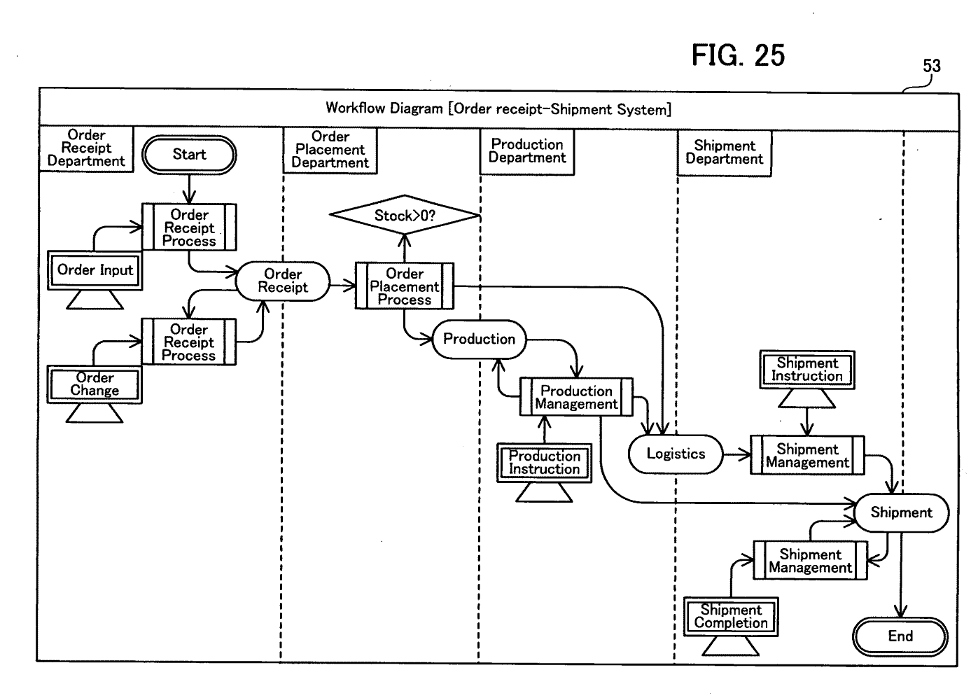

FIG. 25 illustrates a first display example of the workflow diagram. A screen 53 illustrated in FIG. 25 is displayed by the flow diagram displayer 180 on the basis of the flow information illustrated in FIG. 24. In the screen 53, the workflow diagram is displayed with the data table nodes lined up in the direction from the upper left corner to the lower right corner of the display area and also with the display area divided into four lanes. The labels of the individual lanes, namely, “Order Receipt Department”, “Order Placement Department”, “Production Department” and “Shipment Department”, are the names input by the user.

The node indicating the order receipt processing program needs to be located between the start node and the order receipt table node and, therefore, is included in the leftmost order receipt department lane. The order input screen node, which is connected to the order receipt processing program node, also belongs to the same lane as the order receipt processing program node, that is, the order receipt department lane.

As for the other order receipt processing program node and the order change screen node connected thereto, a question could arise as to whether these nodes are to be included in the order receipt department lane or the order placement department lane. Since the order change screen belongs to the same screen group as the order input screen, however, the above two nodes are included in the order receipt department lane. Thus, by dividing the display area into lanes, it is possible to make the user easily understand the associations between the business programs and the operation screens.

The screen illustrated in FIG. 25 displays all of the data table nodes, the business program nodes, the operation screen nodes and the branch condition node. The flow diagram displayer 180 is capable of hiding a certain kind of nodes in response to the user's manipulated input.

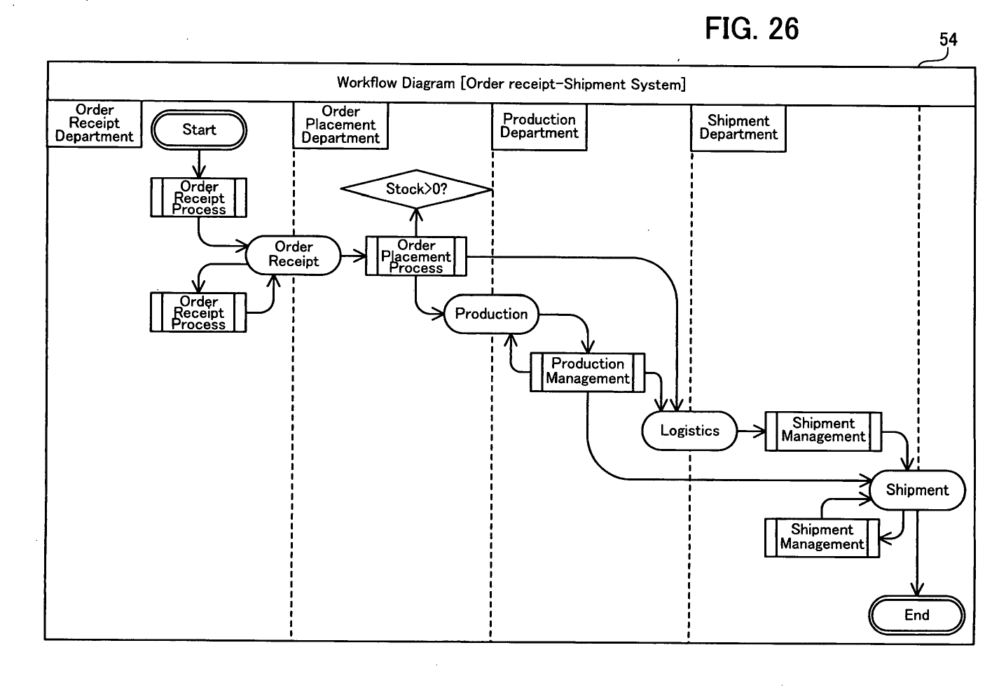

FIG. 26 illustrates a second display example of the workflow diagram. A screen 54 illustrated in FIG. 26 is displayed by the flow diagram displayer 180, wherein the operation screen nodes are hidden, compared with the screen 53 illustrated in FIG. 25. The workflow diagram displayed in the screen 54 is useful especially in the case where the user has to pay attention to the correspondence relationship between the business programs and the updating of the data tables.

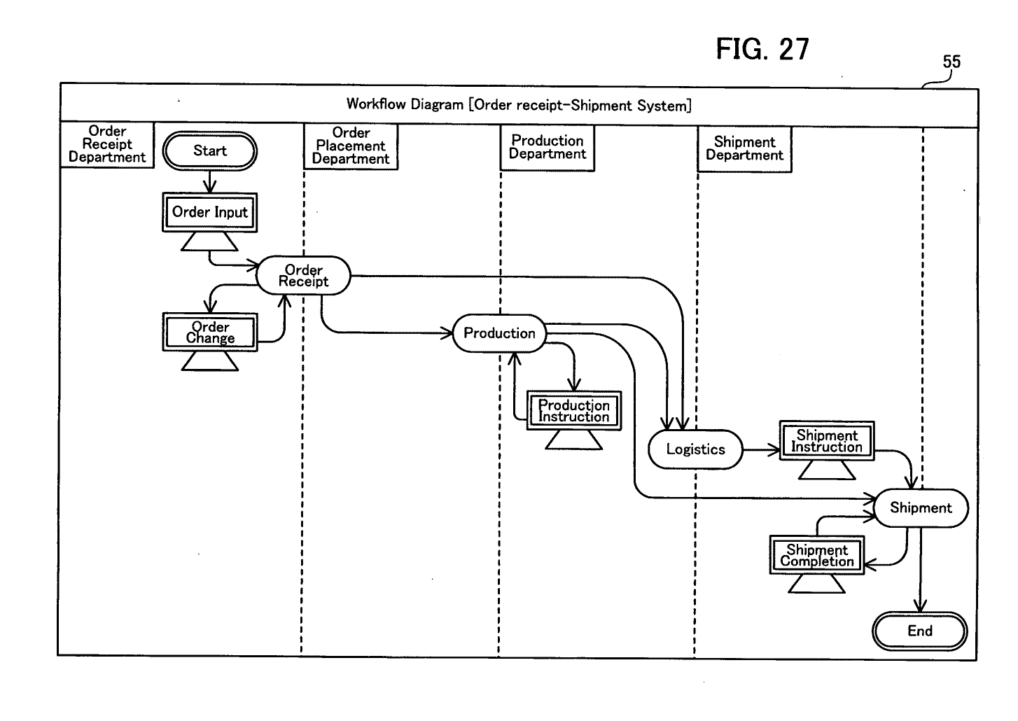

FIG. 27 illustrates a third display example of the workflow diagram. A screen 55 illustrated in FIG. 27 is displayed by the flow diagram displayer 180, wherein the business program nodes are hidden, compared with the screen 53 illustrated in FIG. 25. The workflow diagram displayed in the screen 55 is useful especially in the case where the user has to pay attention to the correspondence relationship between the operation screens and the updating of the data tables.

The use of the business analysis system described above makes it possible to obtain a workflow diagram properly reflecting the operational status of the business system. Since the workflow diagram is generated based on the data tables indicating the data processing results, it is unnecessary to modify the business programs in order to acquire information necessary for the analysis.

Also, since the program information is analyzed as well, it is possible to generate a workflow diagram representing the data tables, the business programs, the operation screens and the branch conditions, thus allowing the user to readily understand the correspondence relationship between these elements. Further, only part of the elements can be displayed, if necessary. Since the workflow diagram is automatically divided into lanes according to screen groups, moreover, the ease of understanding the workflow improves.

In the above embodiments, the operational information is generated by analyzing the data tables themselves but may alternatively be generated by analyzing the update logs output from the database servers 200 and 200a. Also, in the foregoing embodiments, the extraction of processing paths and the extraction of screen groups are carried out separately from each other. The two extraction processes may be executed simultaneously while the program information is analyzed once. Further, in the above embodiments, the operational information extraction process, the path extraction process and the group extraction process are executed in the mentioned order, but these three processes may be executed in different order.

While the workflow diagram generation program, apparatus and method have been described above with reference to the illustrated embodiments, it is to be noted that the present invention is not limited to the foregoing embodiments alone. The constructions of the individual elements may be replaced with those of desired elements having similar functions. Also, the invention may be additionally provided with other desired constructions and processes. Further, two or more desired constructions (features) of the foregoing embodiments may be used in combination.

The processing functions described above can be implemented by a computer. In this case, a program is prepared in which is described the process for performing the functions of the business analysis apparatus 100. The program is executed by a computer, whereupon the aforementioned processing functions are accomplished by the computer. The program describing the process may be recorded on computer-readable recording media. As such computer-readable recording media, magnetic recording devices, optical discs, magneto-optical recording media, semiconductor memories and the like may be used. Magnetic recording devices include a hard disk drive (HDD), a flexible disk (FD) and a magnetic tape (MT). Optical discs include a DVD (Digital Versatile Disc), a DVD-RAM, a CD-ROM (Compact Disc-Read Only Memory), and a CD-R (Recordable)/RW (ReWritable). Magneto-optical recording media include an MO (Magneto-Optical disk).

To market the program, portable recording media, such as DVDs and CD-ROMs, on which the program is recorded may be put on sale. Alternatively, the program may be stored in the storage device of a server computer and may be transferred from the server computer to other computers via a network.

A computer which is to execute the program stores in its storage device the program read from a portable recording medium or transferred from the server computer, for example. Then, the computer loads the program from its storage device and executes the process in accordance with the program. The computer may load the program directly from the portable recording medium to perform the process in accordance with the program. Also, as the program is transferred from the server computer, the computer may sequentially execute the process in accordance with the received program.

According to the present invention, the nodes and the links are organized based on the updating sequence of the data sets managed by the business system, and the information about the operation screens, extracted from the program information, is annexed to the corresponding links. It is therefore possible to quickly obtain a workflow diagram in which the actual workflow is properly reflected and which also indicates the operation screens used in the individual steps of the workflow. Accordingly, the positioning of the individual works within the overall workflow can be easily understood.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that various changes, substitutions and alterations could be made hereto without departing from the spirit and scope of the invention.

What is claimed is:

1. A computer-readable recording medium recording a workflow diagram generation program for generating a workflow diagram matching operational status of a business system,
wherein the workflow diagram generation program causes a computer to function as:
an operational information storage configured to store operational information indicating transition relations each of which is a relation between two data sets successively updated during operation of the business system by a business process involving an update process with respect to a plurality of data sets;
a program information storage configured to store program information indicating a procedure of one or more business programs for implementing the business process by means of the business system;
a path extractor configured to extract processing paths from the program information stored in the program information storage, and generate path information indicating a read process and an update process performed with respect to the data sets in the individual processing paths and operation screens displayed in the processing paths;
a path associator configured to associate each of the transition relations indicated by the operational information stored in the operational information storage, with a processing path of which the data set to be read agrees with the data set of a transition source and of which the data set to be updated agrees with the data set of a transition destination, among the processing paths indicated by the path information generated by the path extractor; and
a flow diagram generator configured to generate, based on association results provided by the path associator, a workflow diagram which indicates the data sets as nodes and the transition relations as links and in which information indicating the operation screens displayed in the processing paths is annexed to corresponding ones of the links.

2. The computer-readable recording medium according to claim 1, wherein:
the workflow diagram generation program causes the computer to function further as a group extractor configured to extract, from the program information, screen groups each of which is a set of the operation screens that can be reached by continuously tracing one or more of the processing paths, and
the flow diagram generator divides the workflow diagram into lanes in accordance with extraction results from the group extractor such that the information indicating the operation screens belonging to an identical one of the screen groups is located within an identical lane.

3. The computer-readable recording medium according to claim 1, wherein the flow diagram generator further annexes, to the links, information indicating the business programs to which the processing paths corresponding to the links belong.

4. The computer-readable recording medium according to claim 1, wherein:
the path extractor generates information indicating a branch condition for a branch decision performed in the individual processing paths and includes the generated information in the path information, and
the flow diagram generator further annexes, to the links, the information indicating the branch conditions included in the processing paths corresponding to the links.

5. The computer-readable recording medium according to claim 1, wherein:
the operational information includes, with respect to each of the transition relations, information indicating an operation inherited item whose value is inherited from a data item of the data set of the transition source to a data item of the data set of the transition destination,
the path extractor generates, with respect to each of the processing paths, information indicating a path inherited item whose value is used in the update process, among the data items read in the read process, and includes the generated information in the path information, and
the path associator determines agreement of the operation inherited item with the path inherited item, as a condition for association in addition to agreement of the data sets.

6. A workflow diagram generation apparatus for generating a workflow diagram matching operational status of a business system, comprising:
an operational information storage configured to store operational information indicating transition relations each of which is a relation between two data sets successively updated during operation of the business system by a business process involving an update process with respect to a plurality of data sets;
a program information storage configured to store program information indicating a procedure of one or more business programs for implementing the business process by means of the business system;
a path extractor configured to extract processing paths from the program information stored in the program information storage, and generate path information indicating a read process and an update process performed with respect to the data sets in the individual processing paths and operation screens displayed in the processing paths;
a path associator configured to associate each of the transition relations indicated by the operational information stored in the operational information storage, with a processing path of which the data set to be read agrees with the data set of a transition source and of which the data set to be updated agrees with the data set of a transition destination, among the processing paths indicated by the path information generated by the path extractor; and
a flow diagram generator configured to generate, based on association results provided by the path associator, a workflow diagram which indicates the data sets as nodes and the transition relations as links and in which information indicating the operation screens displayed in the processing paths is annexed to corresponding ones of the links.

7. The workflow diagram generation apparatus according to claim 6, further comprising a group extractor configured to extract, from the program information, screen groups each of which is a set of the operation screens that can be reached by continuously tracing one or more of the processing paths,
wherein the flow diagram generator divides the workflow diagram into lanes in accordance with extraction results from the group extractor such that the information indicating the operation screens belonging to an identical one of the screen groups is located within an identical lane.

8. The workflow diagram generation apparatus according to claim 6, wherein the flow diagram generator further annexes, to the links, information indicating the business programs to which the processing paths corresponding to the links belong.

9. The workflow diagram generation apparatus according to claim 6, wherein:
the path extractor generates information indicating a branch condition for a branch decision performed in the individual processing paths and includes the generated information in the path information, and
the flow diagram generator further annexes, to the links, the information indicating the branch conditions included in the processing paths corresponding to the links.

10. The workflow diagram generation apparatus according to claim 6, wherein:
the operational information includes, with respect to each of the transition relations, information indicating an operation inherited item whose value is inherited from a data item of the data set of the transition source to a data item of the data set of the transition destination,
the path extractor generates, with respect to each of the processing paths, information indicating a path inherited item whose value is used in the update process, among the data items read in the read process, and includes the generated information in the path information, and
the path associator determines agreement of the operation inherited item with the path inherited item, as a condition for association in addition to agreement of the data sets.

11. A workflow diagram generation method for generating, by means of a computer, a workflow diagram matching operational status of a business system, comprising:
causing a path extractor to extract processing paths from program information stored in a program information storage and indicating a procedure of one or more business programs for implementing, by means of the business system, a business process involving an update process with respect to a plurality of data sets, and to generate path information indicating a read process and an update process performed with respect to the data sets in the individual processing paths and operation screens displayed in the processing paths;
causing a path associator to associate each of transition relations which are indicated by operational information stored in an operational information storage and each of which is a relation between two data sets successively updated by the business process during operation of the business system, with a processing path of which the data set to be read agrees with the data set of a transition source and of which the data set to be updated agrees with the data set of a transition destination, among the processing paths indicated by the path information generated by the path extractor; and
causing a flow diagram generator to generate, based on association results provided by the path associator, a workflow diagram which indicates the data sets as nodes and the transition relations as links and in which information indicating the operation screens displayed in the processing paths is annexed to corresponding ones of the links.

12. The workflow diagram generation method according to claim 11, further comprising causing, while the path information is generated, a group extractor to extract, from the program information, screen groups each of which is a set of the operation screens that can be reached by continuously tracing one or more of the processing paths,
wherein, when generating the workflow diagram, the flow diagram generator divides the workflow diagram into lanes in accordance with extraction results from the group extractor such that the information indicating the operation screens belonging to an identical one of the screen groups is located within an identical lane.

13. The workflow diagram generation method according to claim 11, wherein, when generating the workflow diagram, the flow diagram generator further annexes, to the links, information indicating the business programs to which the processing paths corresponding to the links belong.

14. The workflow diagram generation method according to claim 11, wherein:
when generating the path information, the path extractor generates information indicating a branch condition for a branch decision performed in the individual processing paths and includes the generated information in the path information, and
when generating the workflow diagram, the flow diagram generator further annexes, to the links, the information indicating the branch conditions included in the processing paths corresponding to the links.

15. The workflow diagram generation method according to claim 11, wherein:
the operational information includes, with respect to each of the transition relations, information indicating an operation inherited item whose value is inherited from a data item of the data set of the transition source to a data item of the data set of the transition destination,
when generating the path information, the path extractor generates, with respect to each of the processing paths, information indicating a path inherited item whose value is used in the update process, among the data items read in the read process, and includes the generated information in the path information, and
when associating the transition relations with the processing paths, the path associator determines agreement of the operation inherited item with the path inherited item, as a condition for association in addition to agreement of the data sets.
